(19) United States
(12) Patent Application Publication
(10) Pub. No.: US 2011/0222147 A1
(43) Pub. Date: Sep. 15, 2011

(54) APPARATUS AND METHOD FOR SIMULTANEOUS FLUORESCENCE EXCITATION (2-WAVELENGTHS-IR)

(75) Inventors: Heinrich Ulrich, Heidelberg (DE); Volker Leimbach, Ludwigshafen (DE)

(73) Assignee: LEICA MICROSYSTEMS CMS GMBH, Wetzlar (DE)

(21) Appl. No.: 13/048,173

(22) Filed: Mar. 15, 2011

(30) Foreign Application Priority Data
Mar. 15, 2010 (DE) 10 2010 015 963.8

(51) Int. Cl. G02B 21/06

(52) U.S. Cl. 359/386; 359/385

(57) ABSTRACT

An apparatus in a simultaneous fluorescence excitation microscope is described, allowing simultaneous fluorescence excitation by light of at least two different wavelengths. The apparatus has a laser light source generating a light beam. A first beam splitter splits the light beam into a first partial light beam and a second partial light beam. A wavelength converter converts the wavelength of the first partial light beam. A microscope optical system into which the first partial light beam and the second partial light beam are coupled directs the two partial light beams onto an object to be examined.

### CROSS-REFERENCE TO RELATED APPLICATION

This application claims priority of the German patent application DE 102010015963.8 having a filing date of Mar. 15, 2010. The entire content of this prior German patent application DE 10201015963.8 is herewith incorporated by reference.

### BACKGROUND OF THE INVENTION

The invention relates to an apparatus comprising a fluorescence microscope for simultaneous fluorescence excitation. The apparatus comprises a laser light source with which a light beam is generated. With the aid of a microscope optical system, the light beam is directed onto an object to be examined. Further, the invention relates to a method for simultaneous fluorescence excitation with the aid of the fluorescence microscope.

For the examination of structures and processes in an object to be examined, for example a sample, in particular a tissue sample, it is known to introduce fluorescent dyes into the sample. The dye molecules are coupled in different known manners with molecules in the sample. For example, fluorescent proteins are fused as dye molecules with proteins of the sample, as a result whereof the fluorescent proteins mark the proteins of the sample. For creating such fusion proteins, the DNA of the protein to be examined can, for example, be combined with the DNA of the fluorescent protein and can be brought into a form that can be taken up by the cell so that, subsequently, it creates the fusion protein on its own. The protein to be examined can then still be transported to a predetermined point within the sample, for example a cell. With the aid of laser light, the dye molecules are excited to fluoresce, and the fluorescence light generated in this way is detected, as a result whereof the spatial and temporal distribution of the protein to be examined in the sample, for example a living cell, a tissue or an organism, can be observed. Further, it is known to introduce several different fluorescent dyes, in particular those which emit fluorescence light of different color, into the sample. The different dye particles can then be coupled with different molecules, in particular proteins, in the sample so that different structures and/or processes in the sample can be differentiated from one another.

The different dyes are generally excited with light of different excitation wavelengths. Therefore, fluorescence microscopes are generally coupled to several different laser light sources which each generate light with a different wavelength for exciting the fluorescent dyes. Dye particles which are, in general, used for fluorescence microscopy are, for example, GFP, PA-GFP, PS-CFP, Kaede, Kikume, Dendra or Dronpa.

### SUMMARY OF THE INVENTION

It is the object of the invention to specify an apparatus comprising a fluorescence microscope for simultaneous fluorescence excitation and a method for simultaneous fluorescence excitation with the aid of a fluorescence microscope, which easily enable to simultaneously excite several different fluorescent dyes in an object to fluoresce.

According to a first aspect of the invention the light beam is split into a first partial light beam and a second partial light beam with the aid of a first beam splitter. A wavelength converter converts the wavelength of the first partial light beam. With the aid of a microscope optical system into which the converted first partial light beam and the second partial light beam are coupled the two partial light beams are directed onto an object to be examined.

This enables to illuminate the object with laser radiation of at least two different wavelengths and, thus, to excite at least two different fluorescent dye particles in the object, in particular a sample, to fluoresce. In doing so, a second laser light source can be dispensed with, as a result whereof the entire structure can be easily and cost-efficiently manufactured. In particular in the case of two-photon microscopy, this enables to easily excite different dye particles and proteins and, in this way, to simultaneously make different structures and/or processes in the object, in particular a tissue sample or cell, visible.

In advantageous embodiments, for one partial light beam each or for both partial light beams, one modulator each, one half-wave plate each and/or one polarization filter each are provided which modulate the respective partial light beam, rotate its polarization and polarize the partial light beam, respectively. In addition to the modulation, the rotation of the polarization and the polarization of the partial light beams this enables to separate different signals from one another and/or to attenuate the respective partial light beams.

According to a second aspect of the invention the light beam is split into two partial light beams, the wavelength of one of the two partial light beams being converted. The unconverted and the converted partial light beam are coupled into the microscope optical system which directs the two partial light beams onto the object to be examined.

### BRIEF DESCRIPTION OF THE DRAWINGS

In the following, embodiments of the invention are explained in more detail with reference to schematic drawings.

FIG. 1 shows a first embodiment of an apparatus comprising a fluorescence microscope.

FIG. 2 shows a second embodiment of the apparatus comprising the fluorescence microscope.

Elements having the same structure or function are identified with the same reference signs throughout all Figures.

### DETAILED DESCRIPTION OF THE DRAWINGS

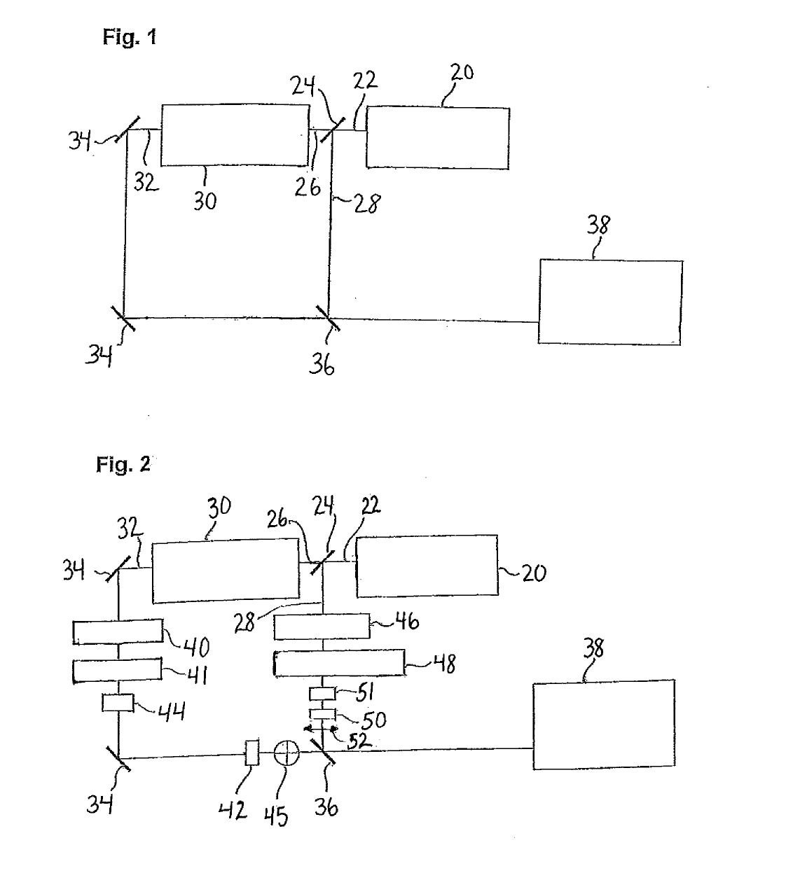

FIG. 1 shows an apparatus comprising a fluorescence microscope. The fluorescence microscope comprises a laser light source 20 generating a light beam 22. The light beam 22 is directed onto a beam splitter 24. The beam splitter 24 splits the light beam 22 into a first partial light beam 26 and a second partial light beam 28 and comprises, for example, a partially reflecting mirror. The first partial light beam 26 passes through a wavelength converter 30. The wavelength converter is an optical parametric oscillator (OPO). Alternatively, another wavelength converter 30 can be provided, for example, the laser light source 20 and the wavelength converter 30 can together form a white light laser, the wavelength converter 30 being the part of the white light laser that splits the narrow-band light of the laser light source 20 into broad-band, i.e. white light. Further, as a wavelength converter 30 also another element can be used that enables a change in the wavelength of the light beam 22, in particular also a laser that is pumped with the aid of the laser light source 20. Further, in the alternative to the embodiment shown, the laser light source 20, the wavelength converter 30 and/or the first beam splitter 24 can be arranged within a single, non-illustrated housing.

A first partial light beam 32 converted with the aid of the wavelength converter 30 is directed via a deflecting mirror 34 onto a beam combiner 36 which combines the converted first partial light beam 32 with the second partial light beam 28 and directs it onto the microscope optical system 38. The microscope optical system 38 comprises in particular an objective, a scanning unit for scanning the object, in particular a sample, and a sample holder.

The laser light source 20 is a titanium-sapphire-laser and generates laser light with a wavelength between 680 and 1080 nm. The wavelength converter 30 converts the wavelength of the first partial light beam 26 such that the converted first partial light beam 32 has wavelengths between 1100 and 1600 nm. In the alternative to the titanium-sapphire-laser also another short-pulse laser, for example a fiber laser or another IR laser can be used.

In the alternative to the fluorescence microscope, the apparatus can comprise a microscope not operating with fluorescent material. In particular, the single laser light source 20 and the wavelength converter 30 can also be arranged in other microscopes. Preferably, however, the microscope optical system 38 corresponds to a known fluorescence microscope except for the light source. The beam splitter 24, the deflecting mirrors 34 and/or the beam combiner 36 can be designed as polarization filters, polarization splitters, color splitters and/or color filters so that in a low-loss manner only light having a predetermined polarization or wavelength is deflected or transmitted to the microscope optical system 38.

As two partial light beams 26, 28 are generated with the aid of the beam splitter 24, with one of the partial light beams, in particular the first partial light beam 26, being converted with the aid of the wavelength converter 30, at least two different fluorescent dye particles or fluorescent proteins in the object can be simultaneously excited to fluoresce.

This is particularly advantageous in two-photon microscopy where by means of approximately simultaneous absorption of two long-wave photons a fluorescent dye molecule is excited such that it emits a short-wave photon. In this connection, in particular the usable wavelength range for the two-photon microscopy can be extended further into the red, in particular infrared range of the fluorescence dyes. In addition, the apparatus, in particular the laser light source 20 and the wavelength converter 30, can be generally used for multi-photon microscopy.

FIG. 2 shows a second embodiment of the apparatus according to FIG. 1. The second embodiment comprises all elements of the first embodiment. In addition, the second embodiment comprises a first modulator 40 modulating the converted first partial light beam 32. The modulated first partial light beam 32 is directed via a first half-wave plate 41 and a first polarization filter 44 onto a first compensation optical system 42. The first compensation optical system 42 images the first partial light beam 32 onto the beam combiner 36. When hitting the beam combiner 36, the first partial light beam 32 is s-polarized with respect to the plane of incidence of the beam combiner 36, which is illustrated in FIG. 2 by a symbol 45 for the s-polarization. In other words, the polarization of the first partial light beam 32 is perpendicular to the plane of incidence of the beam combiner 36.

The first modulator 40 modulates the converted first partial light beam 32. A polarization of the modulated first partial light beam 32 is rotated with the aid of the first half-wave plate 41. Further, the modulated first partial light beam 32 can be polarized, in particular s-polarized, with the aid of the first polarization filter 44. The rotation of the polarization can, in interaction with the polarization of the first partial light beam 32, also be used for the attenuation of the first partial light beam 32. The first compensation optical system 42 corrects a chromatic aberration of the converted first partial light beam 32.

The second partial light beam 28 passes through a second modulator 46, a second half-wave plate 48, a second polarization filter 51 and is incident on a second compensation optical system 50. The second partial light beam 28 is p-polarized when hitting the beam combiner 36, which is illustrated in FIG. 2 by a symbol 52 for the p-polarization. In other words, the polarization of the second partial light beam 28 is parallel to the plane of incidence of the beam combiner 36.

The second modulator 46 modulates the second partial light beam 28. The second half-wave plate rotates a polarization of the second partial light beam 28. For an active rotation of the polarization of the second partial light beam 28, the first and/or second half-wave plate 41, 48 can be coupled with one actuator each, in particular rotated by using a motor. In the alternative or in addition to the modulators 40, 46, the respective partial light beams 28, 32 can also be modulated with the aid of the half-wave plates 41, 48 associated to them. If the half-wave plates 41, 48 are used to modulate the partial light beams 28, 32, the first and second modulator 40, 46, respectively, can be dispensed with. The second polarization filter 51 p-polarizes the second partial light beam 28. The second compensation optical system 50 corrects a chromatic aberration of the second partial light beam 28. The rotation of the polarization and the subsequent polarization of the second partial light beam 28 can be used for the attenuation of the second partial light beam 28.

The two compensation optical systems 42, 50 correct the chromatic aberrations in that a convergence or divergence is impressed on the respective partial light beam 28, 32. In particular, a wavelength-separate compensation of the longitudinal chromatic aberration of the microscope optical system 38 and of the fluorescence microscope is possible with the aid of the compensation optical systems 42, 50. The modulators 40, 46 can be used for a quick switching on and off of one of the two partial light beams 28, 32. As modulators 40, 46, in particular acousto-optic or electro-optic modulators (AOM or EOM) can be used.

The laser light source 20 preferably generates laser light pulses with a duration of about 100 femtoseconds. Alternatively, also other laser light pulses can be generated or permanent light can be generated.

The invention is not restricted to the embodiments as specified. For example, also the wavelengths of both partial light beams 26, 28 can be converted for the simultaneous generation of two laser light beams with different wavelengths. Further, the laser light source 20 and the wavelength converter(s) 30 can be used in arbitrary apparatuses in which laser light of two different wavelengths is required. In the alternative to the embodiment shown in FIG. 2, also less or more additional elements can be present compared to the first embodiment. For example, only one modulator, only one objective system and/or only one polarization filter, in particular in the beam path of only one of the partial light beams 28, 32 can be provided or also several modulators, objective systems and polarization filters can be provided correspondingly. In particular, the modulators, the half-wave plates and the polarization filters require or not require each other as, for example depending on the wavelength converter 30 or modulator used, the respective partial light beam 26, 28 can already be suitably polarized and its polarization no longer has to be rotated or changed. Depending on the need, it may however be important that the two partial light beams 26, 28, when being combined, are differently polarized, for example orthogonally to one another. Further, the light beam 22 can also be split into three or more partial light beams, the wavelengths of which are then at least partially converted by respective wavelength converters so that with only one laser light source 20 several partial light beams of different wavelengths are generated.

### LIST OF REFERENCE SIGNS

20 laser light source
22 light beam
24 beam splitter
26 first partial light beam
28 second partial light beam
30 wavelength converter
32 converted first partial light beam
34 deflecting mirror
36 beam combiner
38 microscope optical system
40 first modulator
41 first half-wave plate
42 first compensation optical system
44 first polarization filter
45 symbol for s-polarization
46 second modulator
48 second half-wave plate
50 second compensation optical system
51 second polarization filter
52 symbol for p-polarization

What is claimed is:

1. An apparatus in a simultaneous fluorescence excitation microscope allowing simultaneous excitation by at least 2 wavelengths, the apparatus comprising:
a laser light source generating a light beam;
a first beam splitter splitting the light beam into a first partial light beam and a second partial light beam;
a wavelength converter converting the wavelength of the first partial light beam; and
a microscope optical system into which the converted first partial light beam and the second partial light beam are coupled and which directs the two partial light beams onto an object to be examined.

2. The apparatus according to claim 1, further comprising at least one of a first modulator modulating the converted first partial light beam and a second modulator modulating the second partial light beam.

3. The apparatus according to claim 1, further comprising at least one of a first half-wave plate rotating the polarization of the converted first partial light beam and a second half-wave plate rotating the polarization of the second partial light beam.

4. The apparatus according to claim 1, further comprising at least one of a first polarization filter polarizing the converted first partial light beam and a second polarization filter polarizing the second partial light beam.

5. The apparatus according to claim 1, wherein the first beam splitter is arranged within a housing of the wavelength converter.

6. The apparatus according to claim 1, wherein the wavelength converter comprises an optical parametric oscillator.

7. The apparatus according to claim 1, wherein the laser light source comprises a titanium-sapphire-laser.

8. The apparatus according to claim 1, wherein the laser light source generates laser light with a wavelength between 680 and 1080 nm and wherein the converted first partial light beam has a wavelength between 1100 and 1600 nm.

9. A method for simultaneous fluorescence excitation by a simultaneous fluorescence excitation microscope, comprising:
generating a light beam with a laser light source;
splitting the light beam into a first partial light beam and a second partial light beam;
converting the wavelength of the first partial light beam; and
is sending the converted first partial light beam and the second partial light beam into a microscope optical system that directs the two partial light beams onto an object to be examined.

10. The method according to claim 9, further comprising modulating at least one of the converted first partial light beam and the second partial light beam.

11. The method according to claim 9, further comprising rotating the polarization of at least one of the converted first partial light beam and the second partial light beam.

12. The method according to claim 9, further comprising polarizing at least one of the converted first partial light beam and the second partial light beam.

13. The method according to claim 9, further comprising generating by the laser light source a laser light comprising a wavelength between 680 and 1080 nm and converting that laser light to a wavelength between 1100 and 1600 nm.

14. The method according to claim 9, further comprising generating by the laser light source a pulsed laser light.
